(19) United States
(12) Patent Application Publication
(10) Pub. No.: US 2025/0190958 A1
(43) Pub. Date: Jun. 12, 2025

(54) METHOD OF TRANSFERRING VIRTUAL ASSET BETWEEN HETEROGENEOUS BLOCKCHAINS

(71) Applicants: SEOUL UNIVERSITY OF FOREIGN STUDIES INDUSTRY ACADEMY COOPERATION FOUNDATION, Seoul (KR); SOONCHUNHYANG UNIVERSITY INDUSTRY ACADEMY COOPERATION FOUNDATION, Chungcheongnam-do (KR)

(72) Inventors: Keundug PARK, Seoul (KR); Heungyoul YOUM, Seoul (KR)

(21) Appl. No.: 18/851,456

(22) PCT Filed: Apr. 27, 2022
(86) PCT No.: PCT/KR2022/005996

§ 371 Date: Sep. 26, 2024

(30) Foreign Application Priority Data
Mar. 31, 2022 (KR) 10-2022-0040515

(51) Int. Cl. G06Q 20/06; G06Q 20/36; G06Q 20/38

(52) U.S. Cl. CPC G06Q 20/0658; G06Q 20/3678; G06Q 20/389

(57) ABSTRACT

Method of transferring virtual asset between heterogeneous blockchains including first and second blockchain comprises receiving deposit of first stable coin from electronic wallets of multiple remittance agents of first blockchain in blockchain-based management system, and receiving deposit, in blockchain-based management system, of second stable coin from electronic wallets of multiple remittance agents of second blockchain in blockchain-based management system, wherein transfer detail of virtual asset transferred from transferor electronic wallet in first blockchain to electronic wallet of first remittance agent selected from among multiple remittance agents of first blockchain is recorded in blockchain-based management system. When transferring virtual asset is confirmed, virtual asset remaining after deducting first remittance agency fee from virtual asset, transfer of which has been identified, is transferred from electronic wallet of second remittance agent selected from among multiple remittance agents of second blockchain to remittance fee electronic wallet of second blockchain.

### TECHNICAL FIELD

The disclosure relates to a method of transferring a virtual asset.

### BACKGROUND ART

With the recent development of information technology (IT), a historic currency changeover period has come following the digitalization across the economy and finance. Thus, various private currencies such as Big Tech's prepayment means, crypto-assets, and stable coins are being emerged, and about 10,000 types of cryptocurrencies are being traded.

As a new electronic currency issued by the central bank, the central bank digital currency (CBDC), in which many countries have recently been interested, refers to a currency whose value is stored electrically and where payments are made through a fund transfer function between users unlike the existing real money.

Social interest in the CBDC has also increased significantly against the backgrounds of the continued decline in cash use, the accelerated digitalization of the economy, the expansion of the cryptocurrency market, and the market dominance issues of Big Tech. In line with this trend, research on the CBDC and preparatory work to introduce the CBDC have been considerably progressed by the central banks in major countries such as the United States, Europe, the United Kingdom, and Japan. The Bank of Korea is skeptical about the necessity of the CBDC, but has continuously conducted studies to promote digital won simulation and research. Further, the Bank of Korea announced that it would conduct a CBDC remittance payment simulation (pilot test) from June 2021 to January 2022

Although practical measures to implement the CBDC have not yet been specified, there have been proposed various technical alternatives, which may be divided according to the centralized or decentralized form of payments into a single ledger technology (account type), in which the central bank or a delegated bank operates the storage and management of information related to payments, and a distributed ledger technology, in which transaction information is distributed and managed by multiple nodes based on the blockchain.

The distributed ledger technology has similar characteristics to the real money based on anonymity because multiple holders, including the central bank, can store and transact balances through electronic wallets.

The distributed ledger technology has advantages of being superior in terms of resilience and security, and, in particular, being able to respond flexibly to changes in the future payment environment. However, the distributed ledger technology is still an early-stage technology, which has fundamental limitations that are difficult to solve in terms of scalability, efficiency, and interoperability.

### DISCLOSURE

### Technical Problem

Recently, overseas remittances using blockchain-based virtual assets are increasing every year.

In terms of interoperability, there have not been proposed efficient heterogeneous inter-blockchain methods between heterogeneous cryptocurrencies, between the cryptocurrency and a central bank digital currency (CBDC), and between heterogeneous CBDCs.

Because various types of cryptocurrencies and CBDCs use different blockchains, it is difficult to transfer virtual asset between a cryptocurrency and another cryptocurrency, between a cryptocurrency and a CBDC, and between a CBDC and another CBDC.

For example, when a remitter has a cryptocurrency A (e.g., Bitcoin) and a remittee wants to receive a cryptocurrency B (e.g., Ethereum), the blockchain of the cryptocurrency A (e.g., Bitcoin) and the blockchain of the cryptocurrency B (e.g., Ethereum) are not compatible with each other, and it is thus difficult to transfer the virtual asset from an electronic wallet of the cryptocurrency A (e.g., Bitcoin) to an electronic wallet of the cryptocurrency B (e.g., Ethereum).

As another example, when a remitter has a cryptocurrency (e.g., Bitcoin) and a remittee wants to receive a CBDC (e.g., digital dollar), the blockchain of the cryptocurrency (e.g., Bitcoin) and the blockchain of the CBDC (e.g., digital dollar) are not compatible with each other, and it is thus difficult to transfer the virtual asset from an electronic wallet of the cryptocurrency (e.g., Bitcoin) to an electronic wallet of the CBDC (e.g., digital dollar).

As another example, when a remitter has a CBDC A (e.g., digital won) and a remittee wants to receive a CBDC B (e.g., digital dollar), the blockchain of the CBDC A (e.g., digital won) and the blockchain of the CBDC B (e.g., digital dollar) are not compatible with each other, and it is thus difficult to transfer the virtual asset from an electronic wallet of the CBDC A (e.g., digital won) to an electronic wallet of the CBDC B (e.g., digital dollar).

To solve this problem, conventionally, a remitter exchanges his/her cryptocurrency A for a cryptocurrency B needed by a remittee at a cryptocurrency exchange, and then transfers cryptocurrency to the remittee's electronic wallet, or a remittance business operator receives the cryptocurrency A from the remitter, exchanges the cryptocurrency A for the cryptocurrency B required for the remittance, and sends virtual asset to the remittee's electronic wallet. Therefore, a remittance process is very inconvenient, and it is very difficult to transfer money between individuals without an intermediary such as the cryptocurrency exchange or the remittance business provider.

An aspect of the disclosure is to provide a method of transferring a virtual asset between heterogeneous blockchains, which is improved in interoperability for heterogeneous inter-blockchain remittance between heterogeneous cryptocurrencies, between the cryptocurrency and a CBDC, and between heterogeneous CBDCs.

However, the problems to be solved by the disclosure are not limited to this, and may be expanded in various ways without departing from the spirit and scope of the disclosure.

### Technical Solution

According to an embodiment of the disclosure, a method of transferring a virtual asset between heterogeneous blockchains including a first blockchain and a second blockchain includes: depositing first stable coins from electronic wallets of a plurality of remittance agents of the first blockchain in a blockchain-based management system; depositing second stables coin from electronic wallets of a plurality of remittance agents of the second blockchain in the blockchain-based management system; and recording remittance details for a virtual asset, which has been transferred from a remitter electronic wallet in the first blockchain to an electronic wallet of a first remittance agent elected from among the plurality of remittance agents in the first blockchain, on the blockchain-based management system, wherein, upon confirmation of completion of transferring the virtual asset, a virtual asset remaining after deducting a first remittance agency fee from the virtual asset, the transfer of which has been confirmed, is transferred from an electronic wallet of a second remittance agent elected from among the plurality of remittance agents in the second blockchain to a remittee electronic wallet in the second blockchain.

A contact node in the first blockchain may provide ledger data, which indicates that the virtual asset has been transferred from the remittee electronic wallet in the first blockchain to the electronic wallet of the first remittance agent, to a contact node of the second blockchain.

The method may further include settling a second remittance agency fee to be paid to the blockchain-based management system by the blockchain-based management system, and paying a third remittance agency fee to the electronic wallet of the first remittance agent.

The method may further include: electing a first remittance agent among a plurality of participation nodes in the first blockchain, which wish to be a remittance agent, by a first consensus algorithm in the blockchain-based management system; and electing a second remittance agent among a plurality of participation nodes in the second blockchain, which wish to be a remittance agent, by a second consensus algorithm in the blockchain-based management system.

The first remittance agent may be fairly elected by the first consensus algorithm from among the participation nodes in the first blockchain, which wish to be the remittance agent and satisfy a condition that the amount of transferring the virtual asset is less than a stable coin deposited in the blockchain-based management system, and the second remittance agent may be fairly elected by the second consensus algorithm from among the participation nodes in the first blockchain, which wish to be the remittance agent and satisfy a condition that the amount of transferring the virtual asset is less than a stable coin deposited in the blockchain-based management system.

The confirmation of completion of transferring the virtual asset may include confirming, at a contact node of the second blockchain, whether the virtual asset has been transferred as much as a remittance amount from the remitter electronic wallet in the first blockchain to the electronic wallet of the first remittance agent.

The remittance details for the virtual asset transferred to the electronic wallet of the elected first remittance agent may include a remitter electronic wallet address of the first blockchain, an electronic wallet address of the remittance agent, a remittance fee to be paid to the first blockchain, and the amount of the virtual asset to be transferred.

The remittance details of transferring the virtual asset remaining after deducting the first remittance agency fee to the remittee electronic wallet of the second blockchain may be recorded on the blockchain-based management system.

The remittance details for the transfer to the remittee electronic wallet of the second blockchain may further include an electronic wallet address of the second remittance agent, a remittee electronic wallet address of the second blockchain, a remittance fee to be paid to the second blockchain, the amount of the virtual asset to be transferred, and the first remittance agency fee.

The method may further include recording a remittance ledger, which indicates that remittance has been made from a remitter in the first blockchain to the electronic wallet of the first remittance agent, on nodes participating in the first blockchain.

The method may further include recording a remittance ledger, which indicates that remittance has been made from the second remittance agent to a remittee in the second blockchain, on nodes participating in the second blockchain.

The blockchain-based management system may receive information about the first blockchain from a contact node of the first blockchain, receive information about the second blockchain from a contact node of the second blockchain, distribute standard operations to the contact node of the first blockchain, and distribute standard operations to the contact node of the second blockchain.

The standard operations may include inter-identification and authentication between the heterogeneous blockchains, an operation for requesting a ledger structure of another blockchain, an operation for requesting data stored in a leger of another blockchain, a ledger data converting operation for converting, processing or combining ledger data received from another blockchain, i.e., the second blockchain according to the leger structure and data format of the first blockchain's own blockchain, a ledger data adding operation for adding the data converted, processed or combined by the ledger data converting operation to the ledger of its own blockchain, and a ledger data deleting operation for deleting the ledger data provided from another blockchain.

### Advantageous Effects

The disclosure may have the following effects. However, it does not mean that a specific embodiment should include all the following effects or only the following effects, and thus the scope of the disclosure should not be construed as being limited by the following effects.

The foregoing method of transferring a virtual asset between heterogeneous blockchains according to embodiments of the disclosure improves the existing remittance method, thereby facilitating the transfer of the virtual asset between individuals without an intermediary such as a cryptocurrency exchange or a remittance business provider.

### DESCRIPTION OF DRAWINGS

FIG. 1 is a conceptual diagram to describe operations of a system for transferring a virtual asset between heterogeneous blockchains when remittance is made between heterogeneous cryptocurrencies according to an embodiment of the disclosure.

FIG. 2 is a conceptual diagram to describe operations of a system for transferring a virtual asset between heterogeneous blockchains when remittance is made between a cryptocurrency and a central bank digital currency (CBDC) according to another embodiment of the disclosure.

FIG. 3 is a conceptual diagram to describe operations of a system for transferring a virtual asset between heterogeneous blockchains when remittance is made between heterogeneous CBDCs according to still another embodiment of the disclosure.

FIG. 4 is a conceptual diagram of a system for transferring a virtual asset between heterogeneous blockchains according to an embodiment of the disclosure.

FIG. 5 is a flow chart to describe standard operations for safely sharing ledger data directly between heterogeneous blockchains without an intermediary according to an embodiment of the disclosure.

FIG. 6 is a flow chart to describe a method of transferring a virtual asset between heterogeneous blockchains according to an embodiment of the disclosure.

FIG. 7 shows an example of a remittance ledger or ledger data indicating that a cryptocurrency (Bitcoin) has been transferred from a remitter electronic wallet of a blockchain A to an agent electronic wallet of a blockchain A.

FIG. 8 shows an example of a remittance ledger indicating that a cryptocurrency (Ethereum) has been transferred from an agent electronic wallet of a blockchain B to a remittee electronic wallet of a blockchain B.

### Mode for Invention

The disclosure may be modified in various ways and have various embodiments, and thus specific embodiments will be illustrated by way of example in the accompanying drawings and described in detail.

It should be understood, however, the drawings and descriptions are not intended to limit the disclosure to the specific embodiments, but cover all modifications, equivalents, and alternatives that fall within the spirit and scope of the disclosure.

Although the terms “first,” “second,” etc. may be used herein to describe various elements, such elements should not be construed as limited by these terms. These terms are only used to distinguish one element from another. For example, a first element may be termed a second element, and the second element may also be termed the first element, without departing from the scope of the disclosure.

When an element is described as being “connected” or “coupled” to another element, it should be understood that the element may be directly connected or joined to another element but intervening elements may be present therebetween. However, when an element is described as being “directly connected” or “directly coupled” to another element, it should be understood that there are no intervening elements therebetween.

The terminology used herein is for the purpose of describing particular embodiments only and is not intended to limit the disclosure. As used herein, the singular forms are intended to include the plural forms as well, unless the context clearly indicates otherwise. It will be further understood that the terms “include” and/or “have” when used herein specify the presence of stated features, numbers, steps, operations, elements, parts, and/or combinations thereof, but do not preclude the presence or addition of one or more other features, numbers, steps, operations, elements, parts, and/or combinations thereof.

Unless otherwise defined, all terms including technical and scientific terms used herein have the same meaning as commonly understood by a person of ordinary skill in the art to which the disclosure pertains. It will be further understood that terms defined in commonly used dictionaries should be interpreted as having a meaning consistent with their meaning in the context of the related art and will not be interpreted in an idealized or overly formal sense unless explicitly defined herein.

Below, a virtual asset includes a cryptocurrency or a central bank digital currency (CBDC).

Methods of transferring virtual assets (e.g., a cryptocurrency, a CBDC, etc.) between heterogeneous blockchains may broadly include three types as follows.

i) Remittance between heterogeneous cryptocurrencies (e.g., Bitcoin, Ethereum, etc.) based on the blockchains—for example, a type where a remitter (or Originator) sends Bitcoin and a remittee (or Beneficiary) receives Ethereum—

ii) Remittance between a cryptocurrency and a CBDC based on the blockchains—for example, a type where a remitter sends Bitcoin and a remittee receives digital won—

iii) Remittance between heterogeneous CBDCs (e.g., digital won, digital dollar, etc.) based on the blockchains—for example, a type where a remitter sends digital won and a remittee receives digital dollar—

Below, exemplary embodiments of the disclosure will be described clearly and in detail with reference to the accompanying drawings so that a person having ordinary knowledge in the art to which the disclosure pertains can easily carry out the disclosure.

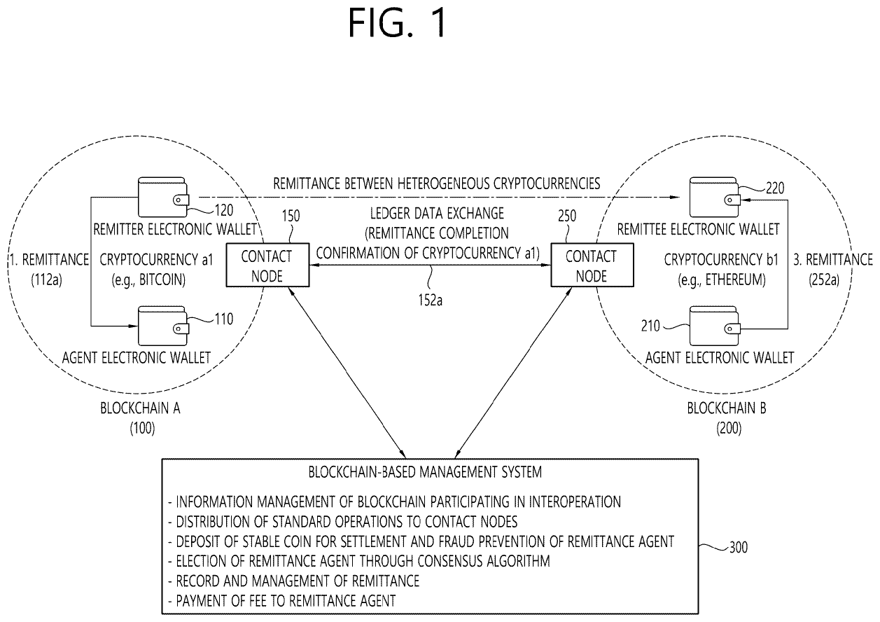

FIG. 1 is a conceptual diagram to describe operations of a system for transferring a virtual asset between heterogeneous blockchains when remittance is made between heterogeneous cryptocurrencies according to an embodiment of the disclosure.

Referring to FIG. 1, by an interoperable operation for remittance between the heterogeneous cryptocurrencies between a blockchain A 100 and a blockchain B 200 of a blockchain-based management system 300, a remitter electronic wallet 120 in the blockchain A 100 transfers a cryptocurrency a1 (e.g., Bitcoin) to an agent electronic wallet 110 in the blockchain A 100, and a contact node 150 of the blockchain A 100 provides ledger data, which indicates that the cryptocurrency a1 (e.g., Bitcoin) has been transferred from the remitter electronic wallet 120 of the blockchain A 100 to the agent electronic wallet 110 of the blockchain A 100, to a contact node 250 of a blockchain B 200. Below, the contact node refers to a node for exchanging the ledger data with the other party's blockchain, which means a data exchange node.

Then, an agent electronic wallet 210 in the blockchain B 200 transfers a cryptocurrency b1 (e.g., Ethereum) corresponding to the amount of the transferred cryptocurrency a1 (e.g., Bitcoin), which has been identified in the ledger data, to a remittee electronic wallet 220 in the blockchain B 200, thereby making remittance between the heterogeneous cryptocurrencies, such as Bitcoin and Ethereum.

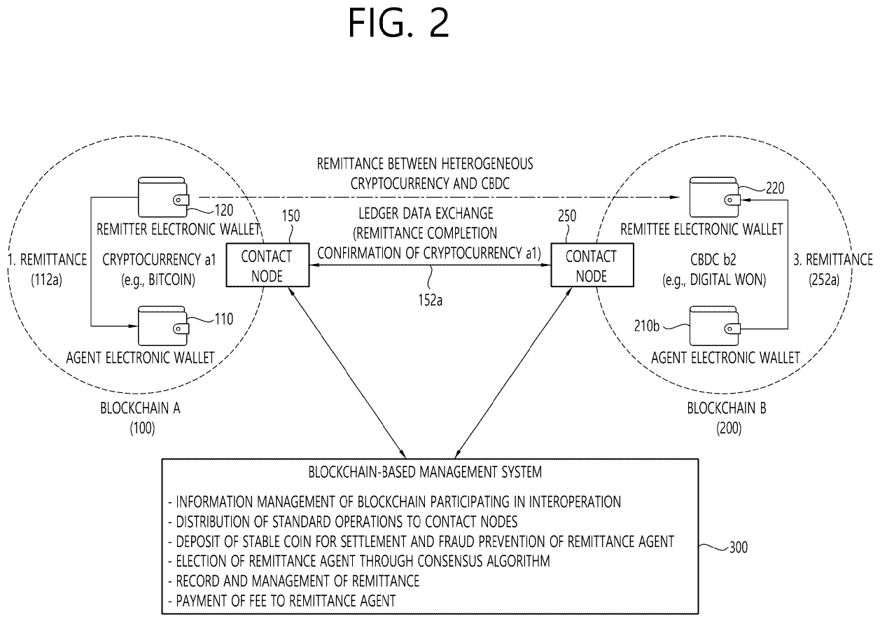

FIG. 2 is a conceptual diagram to describe operations of a system for transferring a virtual asset between heterogeneous blockchains when remittance is made between a cryptocurrency and a CBDC according to another embodiment of the disclosure.

Referring to FIG. 2, by an interoperable operation for remittance between the cryptocurrency and the CBDC between the blockchain A 100 and the blockchain B 200 of the blockchain-based management system 300, the remitter electronic wallet 120 in the blockchain A 100 transfers the cryptocurrency a1 (e.g., Bitcoin) to the agent electronic wallet 110 in the blockchain A 100, and the contact node 150 of the blockchain A 100 provides ledger data, which indicates that the cryptocurrency a1 (e.g., Bitcoin) has been transferred from the remitter electronic wallet 120 of the blockchain A 100 to the agent electronic wallet 110 of the blockchain A 100, to the contact node 250 of the blockchain B 200.

Then, the agent electronic wallet 210b in the blockchain B 200 transfers a CBDC b2 (e.g., digital won) corresponding to the amount of the transferred cryptocurrency a1 (e.g., Bitcoin), which has been identified in the ledger data, to the remittee electronic wallet 220 in the blockchain B 200, thereby making remittance between the heterogeneous virtual assets, such as the cryptocurrency and the CBDC.

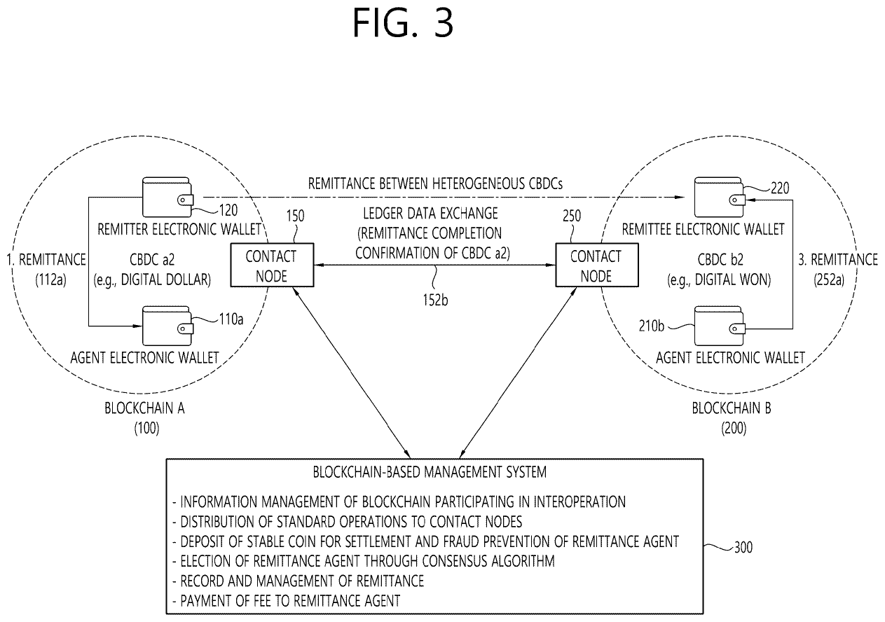

FIG. 3 is a conceptual diagram to describe operations of a system for transferring a virtual asset between heterogeneous blockchains when remittance is made between heterogeneous CBDCs according to still another embodiment of the disclosure.

Referring to FIG. 3, by an interoperable operation for remittance between the heterogenous CBDCs between the blockchain A 100 and the blockchain B 200 of the blockchain-based management system 300, the remitter electronic wallet 120 in the blockchain A 100 transfers a CBDC a2 (e.g., digital dollar) to an agent electronic wallet 110a in the blockchain A 100, and the contact node 150 of the blockchain A 100 provides ledger data, which indicates that the CBDC a2 (e.g., digital dollar) has been transferred from the remitter electronic wallet 120 of the blockchain A 100 to the agent electronic wallet 110a of the blockchain A 100, to the contact node 250 of the blockchain B 200. Then, an agent electronic wallet 210b in the blockchain B 200 transfers the CBDC b2 (e.g., digital won) corresponding to the amount of the transferred CBDC a1 (e.g., digital dollar), which has been identified in the ledger data, to the remittee electronic wallet 220 in the blockchain B 200, thereby making remittance between the heterogeneous virtual assets, such as the heterogeneous CBDCs.

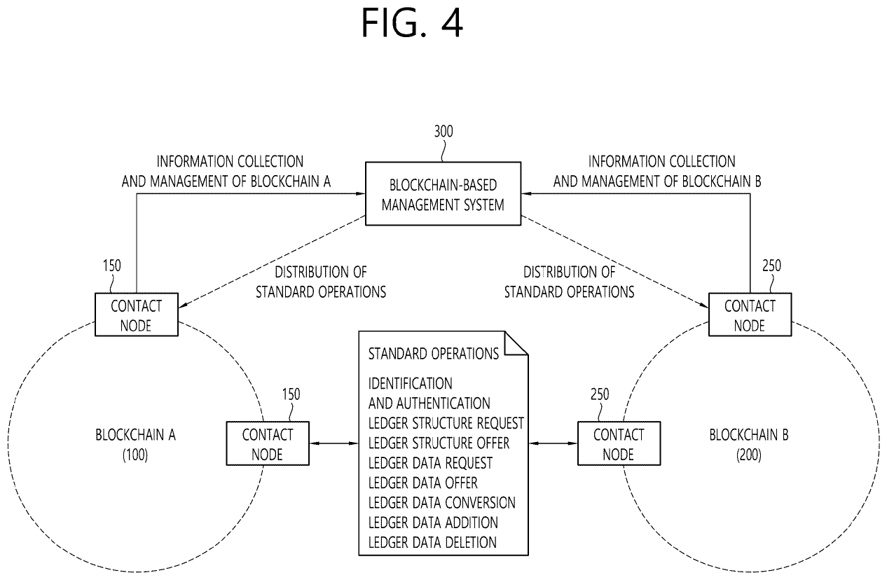

The operations of the contact nodes 150 and 250 and the operations of the blockchain-based management system 300 will be described with reference to FIGS. 4, 5 and 6.

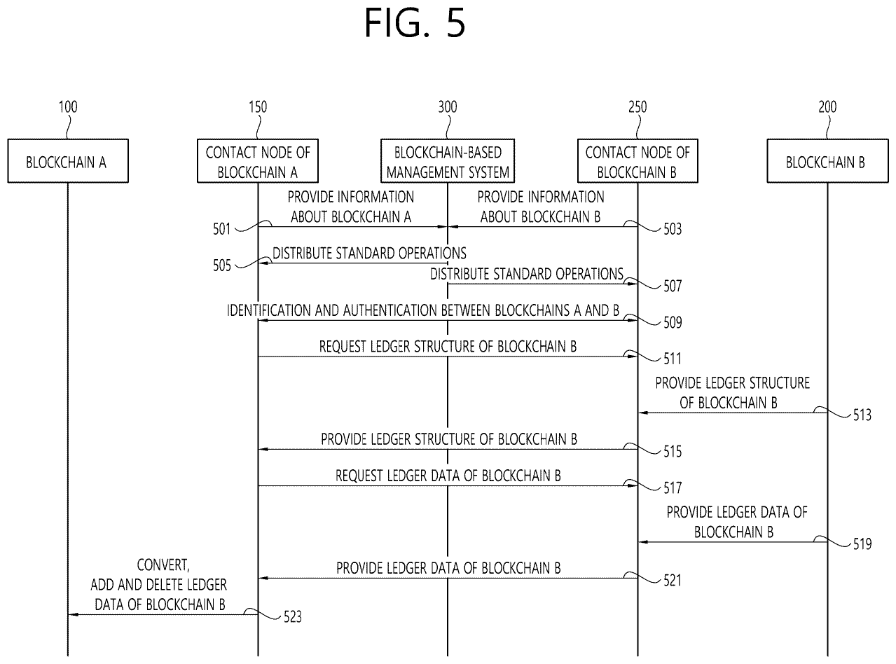

FIG. 4 is a conceptual diagram of a system for transferring a virtual asset between heterogeneous blockchains according to an embodiment of the disclosure. FIG. 5 is a flow chart to describe standard operations for safely sharing ledger data directly between heterogeneous blockchains without an intermediary according to an embodiment of the disclosure. Here, the ledger data safely shared directly between the heterogeneous blockchains without an intermediary refers to the ledger data shared directly between the blockchain A and the blockchain B under the condition that the blockchain-based management system 300 provides only the standard operations to the blockchain A and the blockchain B without relaying data between the blockchain A and the blockchain B.

Below, the operations of the blockchain-based management system in the system for transferring a virtual asset between heterogeneous blockchains according to an embodiment of the disclosure will be described with reference to FIGS. 4 and 5.

The blockchain-based management system 300 collects and manages information about the blockchain A 100 from the contact node 150 of the blockchain A 100, and distributes the standard operations to the contact node 150 of the blockchain A. Further, the blockchain-based management system 300 collects and manages information about the blockchain B 200 from the contact node 250 of the blockchain B 200 and distributes the standard operations to the contact node 250 of the blockchain B.

Here, one contact node may be used in the blockchain A when a virtual asset is transferred between two heterogeneous blockchains, i.e., the blockchain A and the blockchain B, and two contact nodes may be used in the blockchain A when virtual assets are transferred not only between the blockchain A and the blockchain B but also between the blockchain A and a blockchain C.

Here, the information about the blockchain A may include a blockchain name, a consensus algorithm name, a virtual asset name, a contact node Internet protocol (IP) address, etc. The information about the blockchain B may include a blockchain name, a consensus algorithm name, a virtual asset name, a contact node IP address, etc.

Specifically, referring to FIG. 5, the blockchain-based management system 300 receives the information about the blockchain A from the contact node 150 of blockchain A (501) and receives information about the blockchain B from the contact node 250 of the blockchain B (503).

Next, the blockchain-based management system 300 distributes the standard operations to the contact node 150 of the blockchain A (505), and distributes the standard operations to the contact node 250 of the blockchain B (507).

The blockchain-based management system 300 performs operation for inter-identification and authentication between the heterogeneous blockchains, i.e., the blockchain A and the blockchain B (509).

The contact node 150 of the blockchain A requests a ledger structure of the blockchain B from the contact node 250 of the blockchain B in order to perform an operation for requesting a ledger structure of another blockchain (511), and the contact node 250 of the blockchain B receives a ledger structure of the blockchain B from any one of nodes, which participate in the blockchain B, to perform the operation for providing the ledger structure of its own blockchain in response to the ledger structure requesting operation of the blockchain B (513), and provides the ledger structure of the blockchain B to the contact node 150 of the blockchain A (515).

Next, the contact node 150 of the blockchain A requests the ledger data of the blockchain B from the contact node 250 of the blockchain B to perform an operation for requesting data stored in the ledger of another blockchain (517), and the contact node 250 of the blockchain B receives the ledger data of the blockchain B from any one of the nodes, which participate in the blockchain B, to perform the operation for providing the ledger data of its own blockchain in response to the ledger data requesting operation of the blockchain B (519), and provides the ledger data of the blockchain B to the contact node 150 of the blockchain A (521).

The contact node 150 of the blockchain A performs a ledger data converting operation for converting, processing or combining the ledger data received from another blockchain, i.e., the blockchain B according to the ledger structure and data format of its own blockchain, i.e., the blockchain A, all the participation nodes of the blockchain A performs a ledger data adding operation for adding the data converted, processed or combined by the ledger data converting operation to the ledgers of their own blockchains, and the contact node of the blockchain A performs a ledger data deleting operation for deleting the ledger data provided from another blockchain, i.e., the blockchain B (523).

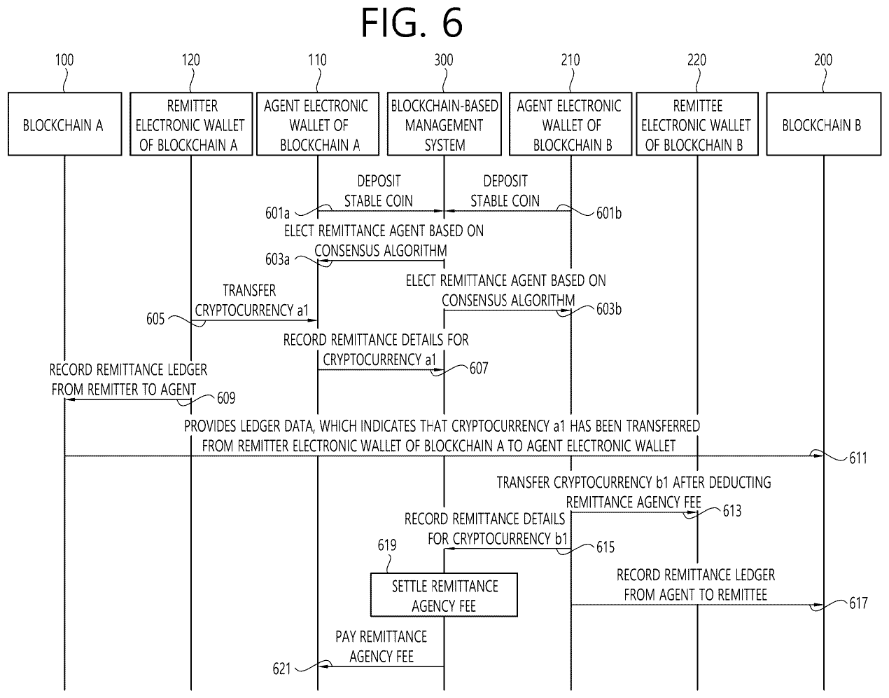

Below, the process of transferring the virtual asset between the heterogeneous blockchains in FIG. 1 will be described in detail with reference to FIG. 6, taking an example that remittance is made between the heterogeneous cryptocurrencies between the heterogeneous blockchains.

FIG. 6 is a flow chart to describe a method of transferring a virtual asset between heterogeneous blockchains according to an embodiment of the disclosure.

Referring to FIG. 6, in the method of transferring the virtual asset between the heterogeneous blockchains according to an embodiment of the disclosure, the agent electronic wallet 110 of the blockchain A first deposits a stable coin in the blockchain-based management system 300 (601a). A plurality of 1, 2, . . . N1 (where, N1 is a natural number) agents may be present in the blockchain A. The plurality of 1, 2, . . . N1 agents in the blockchain A respectively have the agent electronic wallets, so that the stable coins from the respective electronic wallets of the plurality of agents can be deposited in the blockchain-based management system 300 (601a).

Alternatively, one common agent electronic wallet may be present for the plurality of 1, 2, . . . N1 agents in the blockchain A, and the stable coin from the common agent electronic wallet may be deposited in the blockchain-based management system 300 (601a).

The stable coins refer to cryptocurrencies designed to minimize volatility as their values are pegged one to one to fiat currencies such as the dollar. Unlike other virtual currencies, the stable coin has low volatility and is thus used for virtual currency transactions or decentralized financial products. Examples of the stable coins include Tether, J-Coin, JPM Coin, etc. For example, Tether maintains an exchange ratio of 1:1 with the dollar, and J-Coin is stably pegged to 1 coin per 1 yen.

Further, the agent electronic wallet 210 of the blockchain B deposits the stable coin in the blockchain-based management system 300 (601b). A plurality of 1, 2, . . . N2 (where, N2 is a natural number) agents may be present in the blockchain B. The plurality of 1, 2, . . . N2 agents in the blockchain B respectively have the agent electronic wallets, so that the stable coins from the respective electronic wallets of the plurality of agents can be deposited in the blockchain-based management system 300 (601b). Alternatively, one common agent electronic wallet may be present for the plurality of 1, 2, . . . N2 agents in the blockchain B, and the stable coin from the common agent electronic wallet may be deposited in the blockchain-based management system 300 (601b).

In this case, to prevent the agent in the blockchain A or B from defaulting on the remittance business, the amount of stable coin deposited in the blockchain-based management system 300 by each agent in the blockchain A or B in steps 601a and 601b is greater than or equal to the amount of virtual asset—e.g., Bitcoin in FIG. 1—to be transferred by the agent in the blockchain A or B.

Next, the blockchain-based management system 300 elects a remittance agent from among a plurality of participation nodes in the blockchain A by the consensus algorithm (603a). The remittance agent may be elected from the participation nodes, which wish to be the remittance agent, among 1, 2, . . . N1 participation nodes in the blockchain A based on a predetermined condition and the consensus algorithm.

Specifically, in terms of electing the remittance agent in the blockchain A, a specific participation node, of which a virtual asset transfer amount is greater than the stable coin deposited in the blockchain-based management system 300 in step 601a, among 1, 2, . . . N1 participation nodes in the blockchain A, which wish to be the remittance agent, may be designed not to be elected as the remittance agent in order to prevent default on the remittance business. In other words, when the remittance agent in the blockchain A may be fairly elected by the consensus algorithm from among participation nodes in the blockchain A, which wish to be the remittance agent and satisfy the condition that the virtual asset transfer amount is less than the stable coin deposited in the blockchain-based management system 300.

Likewise, the blockchain-based management system 300 elects the remittance agent from among the plurality of participation nodes in the blockchain B by the consensus algorithm (603b). The remittance agent may be elected from the participation nodes, which wish to be the remittance agent, among 1, 2, . . . N2 participation nodes in the blockchain B based on a predetermined condition and consensus algorithm

Specifically, in terms of electing the remittance agent in the blockchain B, the specific participation node, of which a virtual asset transfer amount is greater than the stable coin deposited in the blockchain-based management system 300 in step 601b, among 1, 2, . . . N2 participation nodes in the blockchain B, which wish to be the remittance agent, may be designed not to be elected as the remittance agent in order to prevent default on the remittance business. In other words, when the remittance agent in the blockchain B may be fairly elected by the consensus algorithm from among participation nodes in the blockchain B, which wish to be the remittance agent and satisfy the condition that the virtual asset transfer amount is less than the stable coin deposited in the blockchain-based management system 300.

The remitter electronic wallet 120 of the blockchain A transfers the cryptocurrency a1 (e.g., Bitcoin) desired to be transferred to the agent electronic wallet 110 of the remittance agent elected in step 603a in the blockchain A (605), the agent electronic wallet 110 records remittance details for the cryptocurrency a1 on the blockchain-based management system 300 (607), and the remitter electronic wallet 120 records the remittance ledger, which indicates that the remittance has been sent from the remitter to the agent, on the nodes participating in the blockchain A (609). Alternatively, the remittance ledger indicating that the remittance has been sent from the remitter to the agent may be first recorded on the nodes participating in the blockchain A, and then the remittance details for the cryptocurrency a1 may be recorded on the blockchain-based management system 300.

Here, the remitter electronic wallet refers to the electronic wallet of the remitter, and a ‘private key’ for the remitter's electronic signature may be stored in the electronic wallet of the remitter as encrypted using an encryption key (based on symmetric key encryption). The cryptocurrency has no physical entity and exists as a record on the blockchain. In the process of recording the remittance details on the blockchain A or the blockchain-based management system 300, encryption technologies such as a private key for an electronic signature, and a public key (electronic wallet address), and blockchain technologies such as transmission of the remittance details to the nodes participating in the blockchain A or the blockchain-based management system 300 and going through an approval procedure of the nodes participating in the blockchain A or the blockchain-based management system 300 may be used.

Next, the contact node 150 of the blockchain A provides the ledger data, which indicates that the cryptocurrency a1 has been transferred from the remitter electronic wallet of the blockchain A to the agent electronic wallet 110 of the blockchain A, to the contact node 250 of the blockchain B (611).

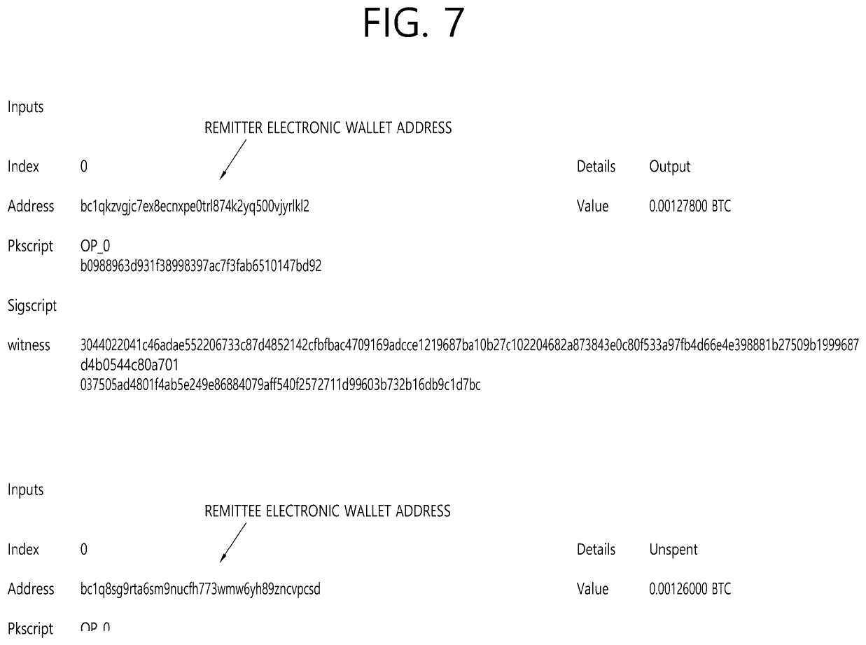

For example, in the case of transferring Bitcoin, the remittance ledger in step 609 and the ledger data in step 611 are shown by way of example in FIG. 7

Referring to FIG. 7, the remittance ledger or ledger data indicating that the cryptocurrency a1 (e.g., Bitcoin) has been transferred from the remitter electronic wallet of the blockchain A to the agent electronic wallet of the blockchain A may include a remitter electronic wallet address (e.g., remitter's public key) and a remittee electronic wallet address (e.g., an agent electronic wallet address, an agent's public key) of the blockchain A in block data of a block that consists of a block header and the block data. Further, the remittance ledger in step 609 and the ledger data in step 611 may further contain the amount of Bitcoin to be transferred.

Next, referring back to FIG. 6, the contact node 210 of the blockchain B checks whether the remittance in step 611 has been completed (612). To check whether the remittance has been completed, the contact node 210 of the blockchain B may check whether the cryptocurrency a1 (e.g., Bitcoin) has been transferred from the remitter electronic wallet of the blockchain A to the agent electronic wallet of the blockchain A as much as the remittance amount.

After confirming that the remittance has been completed, the agent electronic wallet 210 of the blockchain B calculates the cryptocurrency b1 (e.g., Ethereum) corresponding to the amount of the cryptocurrency a1 (e.g., Bitcoin), the remittance of which has been confirmed, and transfers the cryptocurrency b1 (e.g., Ethereum), which remains after deducting a first remittance agency fee from the calculated cryptocurrency b1 (e.g., Ethereum), to the remittee electronic wallet of the blockchain B (613). When Ethereum is transferred from the blockchain B, the stable coin corresponding to the amount of Ethereum to be transferred may be paid to the agent electronic wallet 210 of the blockchain B as the first remittance agency fee. For example, when 0.1 Ethereum is transferred from the agent electronic wallet 210 of the blockchain B to the remittee electronic wallet of the blockchain B, the stable coin equivalent to 0.03 Ethereum may be deducted as the remittance agency fee and paid to the agent electronic wallet 210 of the blockchain B, and 0.07 Ethereum remaining after the deduction may be transferred to the remittee electronic wallet of the blockchain B.

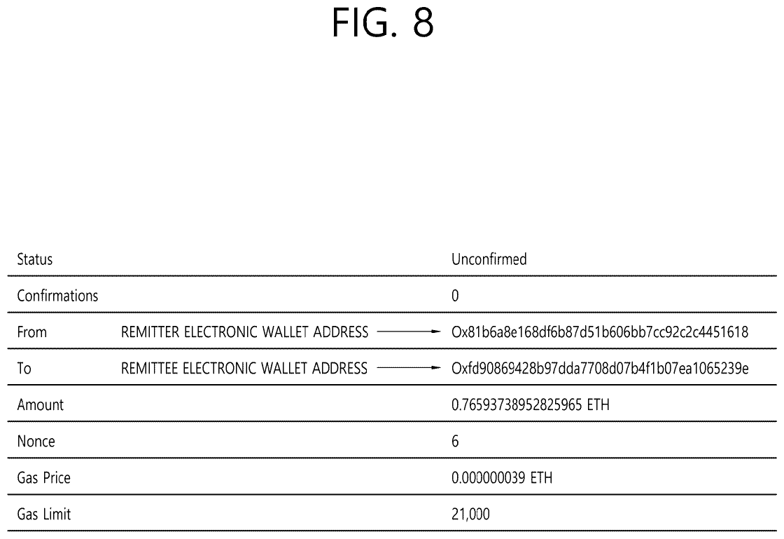

Next, the remittance details for the cryptocurrency b1 (e.g., Ethereum) transferred in step 613 are recorded on the blockchain-based management system 300 (615), and the remittance ledger indicating that the remittance has been sent from the agent to the remittee is recorded on the nodes participating in the blockchain B. Alternatively, the remittance ledger indicating that the remittance has been sent from the agent to the remittee may be first recorded on the nodes participating in the blockchain B, and then the remittance details for the cryptocurrency b1 may be recorded on the blockchain-based management system 300. The remittance details for the cryptocurrency b1 may include a remitter electronic wallet address, a remittee electronic wallet address, the quantity (or amount) of cryptocurrency, a remittance fee to be paid to the corresponding blockchain, and a fee to be paid to a remittance agent. In other words, the remittance details for the cryptocurrency b1 further include a remittance fee to be paid to the blockchain B, the amount of Ethereum to be transferred, and the first remittance agency fee (or a fee to be paid to the remittance agent of the blockchain B) in addition to the transfer data of FIG. 8.

Next, the blockchain-based management system 300 settles a second remittance agency fee by deducting the amount of the second remittance agency fee to be paid to the blockchain-based management system 300 (619), and the blockchain-based management system 300 pays a third remittance agency fee to the agent electronic wallet 110 of the blockchain A (621). Alternatively, the settlement of the second remittance agency fee in step 619 may be performed after the payment of the third remittance agency fee in step 621.

Here, the second and/or third remittance agency fee may be settled or paid with the foregoing deposited stable coin. The third remittance agency fee paid to the agent electronic wallet 110 of the blockchain A and the second remittance agency fee deducted by the agent electronic wallet 210 of the blockchain B may be allocated at a ratio of, for example, 1:1, or one of the remittance agency fees may be allocated to be higher than the other one.

For example, in the case of transferring Ethereum, the remittance ledger in step 617 of FIG. 6 is shown by way of example in FIG. 8.

Referring to FIG. 8, the remittance ledger indicating that the cryptocurrency a1 (e.g., Ethereum) has been transferred from the agent electronic wallet 210 of the blockchain B to the remittee electronic wallet 220 of the blockchain B may include a remitter electronic wallet address (e.g., agent's public key) and a remittee electronic wallet address (e.g., a remittee electronic wallet address, a remittee's public key) of the blockchain B in block data of a block that consists of a block header and the block data. Further, the remittance ledger in step 617 may further contain the amount of Ethereum to be transferred.

The operations of the method of transferring a virtual asset between the heterogeneous blockchains according to the foregoing embodiments of the disclosure may be implemented as computer-readable codes on a computer-readable recording medium. The computer-readable recording media include all types of recording media storing data to be decrypted by a computer system. For example, the computer-readable recording media may include a read only memory (ROM), a random-access memory (RAM), a magnetic tape, a magnetic disk, a flash memory, an optical data storage device, etc. Further, the computer-readable recording medium may be distributed to computer systems connected through a computer communication network, and stored and executed as a code to be readable in a distributed manner.

Although the descriptions have been made as above with reference to the accompanying drawings and the embodiments, it does not mean that the scope of the disclosure is limited by these drawings or embodiments, and it will be understood that various modifications and changes can be made by those skilled in the art without departing from the spirit and scope of the disclosure as set forth in the appended claims below.

1. A method of transferring a virtual asset between heterogeneous blockchains having a first blockchain and a second blockchain, the method comprising:
depositing first stable coins from electronic wallets of a plurality of remittance agents of the first blockchain in a blockchain-based management system;
depositing second stable coins from electronic wallets of a plurality of remittance agents of the second blockchain in the blockchain-based management system; and
recording remittance details for a virtual asset, which has been transferred from a remitter electronic wallet in the first blockchain to an electronic wallet of a first remittance agent elected from among the plurality of remittance agents in the first blockchain, on the blockchain-based management system,
wherein, upon confirmation of completion of transferring the virtual asset, a virtual asset remaining after deducting a first remittance agency fee from the virtual asset, the transfer of which has been confirmed, is transferred from an electronic wallet of a second remittance agent elected from among the plurality of remittance agents in the second blockchain to a remittee electronic wallet in the second blockchain.

2. The method of claim 1, wherein a contact node in the first blockchain provides ledger data, which indicates that the virtual asset has been transferred from the remittee electronic wallet in the first blockchain to the electronic wallet of the first remittance agent, to a contact node of the second blockchain.

3. The method of claim 1, further comprising settling a second remittance agency fee, by the blockchain-based management system, to be paid to the blockchain-based management system by the blockchain-based management system, and paying a third remittance agency fee to the electronic wallet of the first remittance agent.

4. The method of claim 1, further comprising:
electing a first remittance agent among a plurality of participation nodes in the first blockchain, which wish to be a remittance agent, by a first consensus algorithm in the blockchain-based management system; and
electing a second remittance agent among a plurality of participation nodes in the second blockchain, which wish to be a remittance agent, by a second consensus algorithm in the blockchain-based management system.

5. The method of claim 1, wherein
the first remittance agent is fairly elected by the first consensus algorithm from among the participation nodes in the first blockchain, which wish to be the remittance agent and satisfy a condition that the amount of transferring the virtual asset is less than a stable coin deposited in the blockchain-based management system, and
the second remittance agent is fairly elected by the second consensus algorithm from among the participation nodes in the first blockchain, which wish to be the remittance agent and satisfy a condition that the amount of transferring the virtual asset is less than a stable coin deposited in the blockchain-based management system.

6. The method of claim 1, wherein the confirmation of completion of transferring the virtual asset comprises confirming, at a contact node of the second blockchain, whether the virtual asset has been transferred as much as a remittance amount from the remitter electronic wallet in the first blockchain to the electronic wallet of the first remittance agent.

7. The method of claim 1, wherein the remittance details for the virtual asset transferred to the electronic wallet of the elected first remittance agent comprise a remitter electronic wallet address of the first blockchain, an electronic wallet address of the remittance agent, a remittance fee to be paid to the first blockchain, and the amount of the virtual asset to be transferred.

8. The method of claim 1, wherein the remittance details of transferring the virtual asset remaining after deducting the first remittance agency fee to the remittee electronic wallet of the second blockchain are recorded on the blockchain-based management system.

9. The method of claim 8, wherein the remittance details for the transfer to the remittee electronic wallet of the second blockchain further comprise an electronic wallet address of the second remittance agent, a remittee electronic wallet address of the second blockchain, a remittance fee to be paid to the second blockchain, the amount of the virtual asset to be transferred, and the first remittance agency fee.

10. The method of claim 1, further comprising recording a remittance ledger, which indicates that remittance has been made from a remitter in the first blockchain to the electronic wallet of the first remittance agent, on nodes participating in the first blockchain.

11. The method of claim 1, further comprising recording a remittance ledger, which indicates that remittance has been made from the second remittance agent to a remittee in the second blockchain, on nodes participating in the second blockchain.

12. The method of claim 1, wherein the blockchain-based management system receives information about the first blockchain from a contact node of the first blockchain, receives information about the second blockchain from a contact node of the second blockchain, distributes standard operations to the contact node of the first blockchain, and distributes the standard operations to the contact node of the second blockchain.

13. The method of claim 1, wherein the standard operations comprise inter-identification and authentication between the heterogeneous blockchains, an operation for requesting a ledger structure of another blockchain, an operation for requesting data stored in a leger of the another blockchain, a ledger data converting operation for converting, processing or combining ledger data received from the another blockchain, i.e., the second blockchain according to the leger structure and data format of the first blockchain, a ledger data adding operation for adding the data converted, processed or combined by the ledger data converting operation to the ledger of the first blockchain, and a ledger data deleting operation for deleting the ledger data provided from the another blockchain.
